(19) United States
(12) Patent Application Publication
(10) Pub. No.: US 2015/0297925 A1
(43) Pub. Date: Oct. 22, 2015

(54) INTELLIGENT SPRINKLER SYSTEM SECTION VALVE

(71) Applicant: MARIOFF CORPORATION OY, Vantaa (FI)

(72) Inventors: Juha-Pekka Nikkarila, Tervakoski (FI); Pasi Pennanen, Vantaa (FI)

(73) Assignee: Marioff Corporation Oy, Vantas (FI)

(21) Appl. No.: 14/648,329

(22) PCT Filed: Nov. 30, 2012
(86) PCT No.: PCT/FI2012/051187

§ 371 Date: May 29, 2015

(51) Int. Cl. A62C 35/60

(52) U.S. Cl. CPC A62C 35/60

(57) ABSTRACT

Embodiments are directed to a sprinkler system (200) having a valve (204, 206, 208, 352) for discharging a liquid to suppress fire, a sensor (214) disposed at the valve, the sensor configured to provide an output indicating a flow of liquid, and a processor disposed at the valve, the processer processing the output of the sensor to provide an indication of liquid flow at the valve.

### BACKGROUND

In order to promote safety, it is desirable to determine the location of a fire as quickly as possible. For example, a rapid determination may enable one to extinguish the fire before property is damaged or someone sustains an injury.

Sprinkler systems (e.g., wet pipe sprinkler systems) are in frequent use today. When a pump unit of the sprinkler system is activated or engaged, a flow sensor associated with a valve (e.g., a section valve) of the sprinkler system may detect or signal a flow of liquid (e.g., water). The flow signal may end after a line of the system is filled with water and pressure stabilizes, if, for example, none of the sprinklers on the line are activated. In order to preclude reporting a flow that is not actually present, a delay or filter mechanism is used until the pressure stabilizes as described above.

### BRIEF SUMMARY

One or more embodiments are directed to a sprinkler system comprising a valve for discharging a liquid to suppress fire, a sensor disposed at the valve, the sensor configured to provide an output indicating a flow of liquid, and a processor disposed at the valve, the processer processing the output of the sensor to provide an indication of liquid flow at the valve.

One or more embodiments are directed to a method comprising detecting, by a valve, a flow of liquid associated with a sprinkler system, processing, at the valve, the detected flow, and transmitting, by the valve, an indication of the detected flow based on the processing.

One or more embodiments are directed to a valve for discharging liquid, comprising: a sensor configured to provide an output indicating a flow of the liquid; and a processor configured to process the output of the sensor and to provide an indication of liquid flow at the valve.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 illustrates an exemplary sprinkler system in accordance with the prior art;

FIG. 2 illustrates an exemplary sprinkler system in accordance with one or more embodiments of this disclosure;

FIGS. 3A-3B illustrate models for one or more intelligent section valves in accordance with one or more embodiments of this disclosure; and

FIG. 4 illustrates a flowchart of an exemplary method in accordance with one or more embodiments of this disclosure.

### DETAILED DESCRIPTION

Exemplary embodiments of apparatuses, systems and methods are described for enhancing the operation of a sprinkler system. In some embodiments, operation may be enhanced by reducing a time it takes to determine whether a flow of liquid (e.g., water) is present in a valve or section of valves.

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this regard, a coupling of entities may refer to either a direct or an indirect connection.

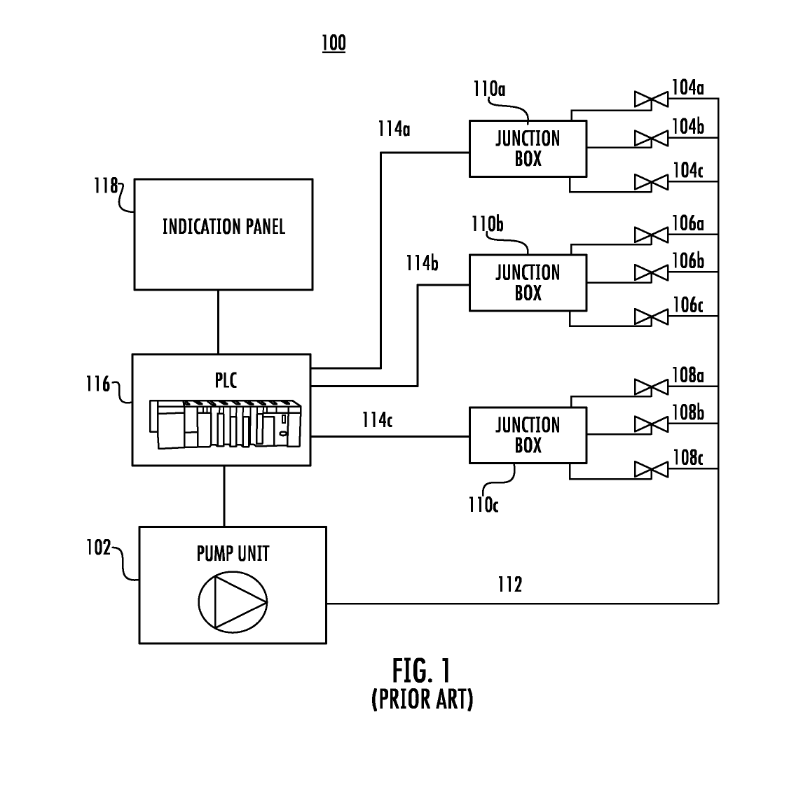

FIG. 1 illustrates a system 100 in accordance with the prior art. The system 100 may include a pump unit 102, which may be used to pump or supply liquid (e.g., water) to fight or extinguish a fire. For example, the pump unit 102 may supply water to one or more valves (e.g., valves 104a 104b, 104c, 106a, 106b, 106c, 108a, 108b, and 108c) via a piping 112.

In some embodiments, the system 100 may correspond to a wet-pipe sprinkler system, in which the piping 112 may be at least partially full of liquid, such that liquid may be discharged immediately in response to a detected fire. The valves 104a 104b, 104c, 106a, 106b, 106c, 108a, 108b, and 108c may be “normally open” in such a configuration so as to enable a flow of liquid to assist in extinguishing the fire.

In some embodiments, the valves 104a 104b, 104c, 106a, 106b, 106c, 108a, 108b, and 108c may be associated with one or more junction boxes, such as junction boxes 110a, 110b, and 110c. As shown in FIG. 1, the valves 104a 104b, 104c may be associated with the junction box 110a, the valves 106a 106b, 106c may be associated with the junction box 110b, and the valves 108a 108b, 108c may be associated with the junction box 110c.

Each of the valves 104a 104b, 104c, 106a, 106b, 106c, 108a, 108b, and 108c include a sensor configured to indicate whether a flow of liquid is detected with respect to the valve. The valves 104a 104b, 104c, 106a, 106b, 106c, 108a, 108b, and 108c are configured to convey the flow indication to their respective junction boxes 110a, 110b, and 110c. The junction boxes 110a-110c, in turn, convey the flow indication to a PLC 116 via cables 114a, 114b, and 114c as shown in FIG. 1. The cabling 114a-114c may include a wire for each type of signal to be conveyed by a valve (e.g., flow and valve position indications). Such cabling 114a-114c represents a cost in terms of materials and maintenance. Furthermore, such cabling 114a-114c represents a potential point of failure in the system.

The flow indication provided by, for example, sensors included in the valves 104a 104b, 104c, 106a, 106b, 106c, 108a, 108b, and 108c may be susceptible to “false positives.” For example, until pressure stabilizes in the system 100, a sensor at a given one of the valves 104a 104b, 104c, 106a, 106b, 106c, 108a, 108b, and 108c might indicate that a flow of liquid is present, when in actuality such a flow might not be present. In this regard, it may be difficult to pinpoint the location of a fire if all the sensors indicate the presence of a flow.

In order to address the “false positive” aspect of the flow indication, the PLC 116 may implement a filter or delay mechanism to hold-off on reporting a flow to another entity, such as an indication panel 118. For example, the PLC 116 may be configured to delay all flow indicators received from the junction boxes 110a-110c for a period of time (e.g., one to three minutes) in order to let system pressure stabilize.

The indication panel 118 may be used by, e.g., fire personnel or a building owner or operator to allocate resources in fighting a fire. For example, the indication panel 118 may provide status regarding which flow signal or indicators are “on” or “active.” If the PLC 116 is forced to delay the reporting of the flow indicators in accordance with the above, a user of the indication panel 118 might be deprived of valuable information during that delay.

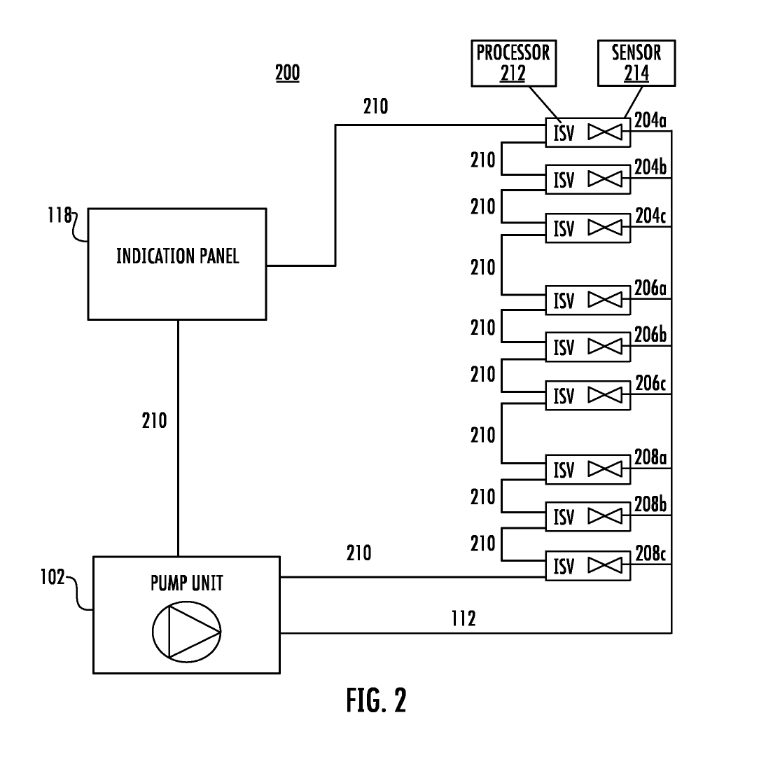

FIG. 2 illustrates an exemplary sprinkler system 200 in accordance with one or more embodiments of this disclosure. The system 200 may include a number of valves, such as intelligent section valves (ISVs) 204a, 204b, 204c, 206a, 206b, 206c, 208a, 208b, and 208c.

The ISVs 204a, 204b, 204c, 206a, 206b, 206c, 208a, 208b, and 208c may be configured to utilize pressure derivative (e.g., pre-action valve control) and/or pressure difference over valve techniques to detect and identify changes (e.g., activation, standby, pumping or jockey pumping, etc.) in system operation. For example, in some embodiments one or more valves may be equipped with a back flow valve that may be configured to prevent or slow down a back flow of liquid (e.g., water). When a sprinkler is activated, liquid may flow through the sprinkler, and the pressure derivative (e.g., the change in pressure with respect to time, dP/dt) of the associated valve may drop rapidly. All other valves may experience no pressure change because their back flow valves may prevent the liquid from going through the section valve and into the section where the sprinkler has been activated, or if the back flow is merely slowed by the back flow valves then a processor may identify such a condition due to flow direction and/or a slower change in pressure.

Relative to their counterpart valves 104a 104b, 104c, 106a, 106b, 106c, 108a, 108b, and 108c, the ISVs 204a, 204b, 204c, 206a, 206b, 206c, 208a, 208b, and 208c may include intelligence. For example, the intelligence or functionality associated with the PLC 116 may be incorporated in one or more of the ISVs 204a, 204b, 204c, 206a, 206b, 206c, 208a, 208b, and 208c. In some embodiments, the intelligence may be distributed as well. For example, in some embodiments the intelligence may be at least partially incorporated into other entities, such as the pump unit 102 and/or the indication panel 118.

In some embodiments, the ISVs 204a, 204b, 204c, 206a, 206b, 206c, 208a, 208b, and 208c may include one or more processors, and memory having instructions stored thereon that, when executed by the one or more processors, cause the ISVs 204a, 204b, 204c, 206a, 206b, 206c, 208a, 208b, and 208c to perform one or more methodological acts as described herein. Such a processor 212 is shown in FIG. 2, along with a sensor 214, in connection with the ISV 204a. The sensor 214 may be configured to provide an output indicating a flow of liquid, such as flow of liquid through the ISV 204a.

The ISVs 204a, 204b, 204c, 206a, 206b, 206c, 208a, 208b, and 208c may be configured to communicate over one or more media 210. The media 210 may include any type of communication interface, such as wireless communications, cable/phone communications, optical communications, etc. In some embodiments, the medium(s) 210 may be similar to the cabling 114 of FIG. 1, but might not include a hard-wiring of a signal for any particular function or indication. In other words, any given medium 210 may be used to convey information, data, status, or indication of any type(s).

The ISVs 204a, 204b, 204c, 206a, 206b, 206c, 208a, 208b, and 208c are shown as being coupled or daisy-chained to one another via the media 210. Accordingly, the ISVs 204a, 204b, 204c, 206a, 206b, 206c, 208a, 208b, and 208c may be configured to communicate with one another. Other configurations may be used. For example, one or more of the ISVs 204a, 204b, 204c, 206a, 206b, 206c, 208a, 208b, and 208c may be configured to communicate with an (external) entity not shown in FIG. 2. Relative to the system 100 (and its cabling 114a-114c), the media 210 may reduce the actual components/infrastructure used in a communication path. In some embodiments, the media 210 may be associated with pre-assembled, plug-in connectors in order to minimize connection work or labor.

In the system 200, the ISV 204a may be directly coupled to the indication panel 118. Similarly, the ISV 208c may be directly coupled to the pump unit 102. Such a configuration may be contrasted with the system 100, wherein none of the valves 104a 104b, 104c, 106a, 106b, 106c, 108a, 108b, and 108c is directly, communicatively coupled to the pump unit 102 or the indication panel 118.

The system 200 may enable a rich feature-set to be realized. For example, remote monitoring, line monitoring, self-diagnostics, automatic self-testing, etc. may be realized using the system 200. Such features may be utilized in connection with serial communications between one or more entities or devices.

The system 200 is illustrative. In some embodiments, some of the components or devices may be optional. In some embodiments, the components or devices may be arranged in a manner different from what is shown in FIG. 2. In some embodiments, one or more additional components or devices not specifically shown may be included. For example, in some embodiments, pipes and/or nozzles may be included. The pipes/nozzles may be associated with one or more of the section valves 204a, 204b, 204c, 206a, 206b, 206c, 208a, 208b, and 208.

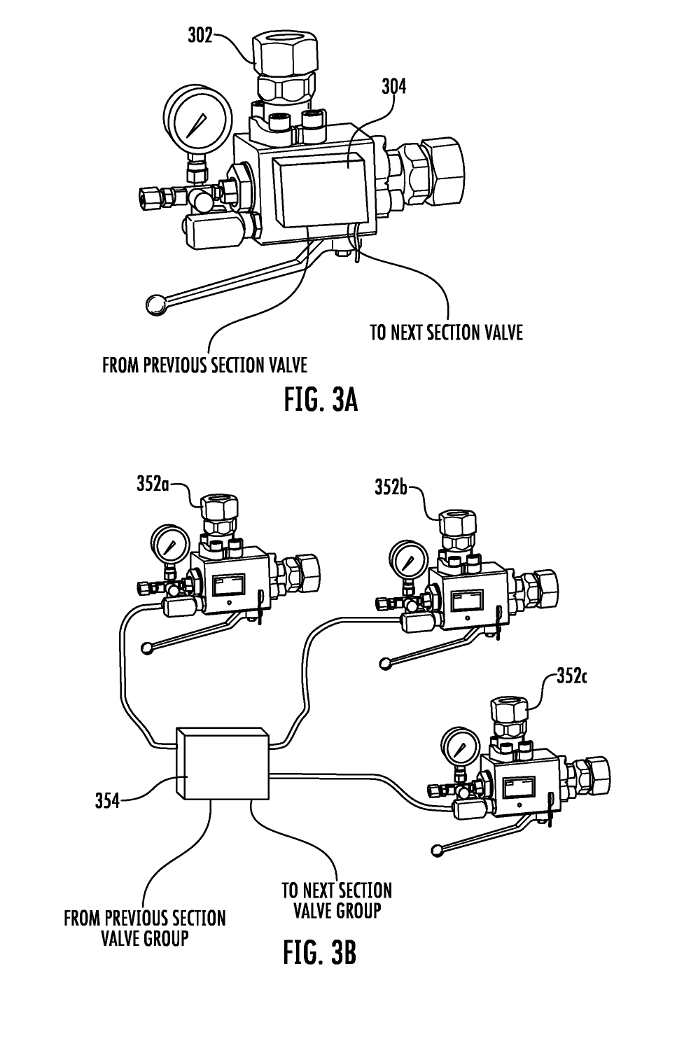

FIGS. 3A-3B illustrate models that may be utilized for an ISV, such as one or more of the ISVs 204a, 204b, 204c, 206a, 206b, 206c, 208a, 208b, and 208c. In FIG. 3A, a standalone model for an ISV 302 is shown, in which the ISV 302 may receive one or more signals from a previous or first ISV via a medium 304, and may convey or transmit the received signal(s) and/or signal(s) generated by the ISV 302 to a next or second ISV via the medium 304. Indicia may be used in connection with signals to identify what entity (e.g., what valve) a particular signal originated from, what entity communicated a given signal, etc. The configuration of FIG. 3A may be analogous to the daisy-chain configuration of FIG. 2.

FIG. 3B illustrates an integrated model for an ISV, wherein ISVs 352a, 352b, and 352c may form a group and may be communicatively coupled to another valve, ISV, and/or group of valves or ISVs via a medium 354. In this regard, the medium 354 may be common to the ISVs 352a, 352b, and 352c of the group.

In some embodiments, the media 304 and/or 354 may correspond to the media 210. The media 304 and 354 may provide support for potential free contacts to be used. Potential free contacts may correspond to contacts that are operated (e.g., physically operated) with a device under consideration, but not electrically connected to that device. Such potential free contacts may be used in environments where safety or isolation between system components is desired or needed.

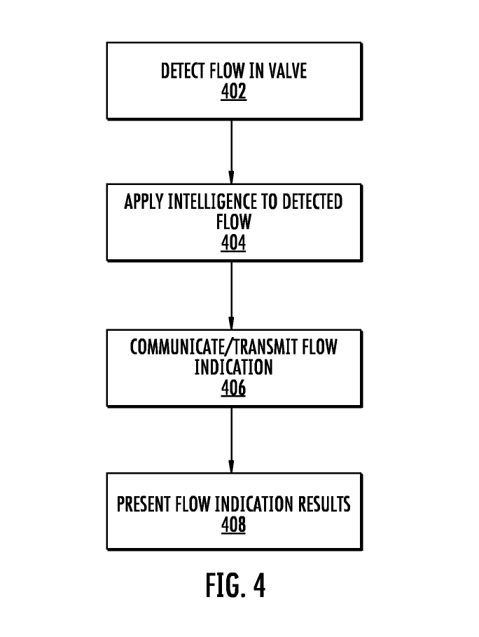

FIG. 4 illustrates a flowchart of a method in accordance with one or more embodiments of this disclosure. The method of FIG. 4 may be operative in accordance with one or more systems or entities, such as those described herein. The method of FIG. 4 may be used to convey an indication or status, such as an indication of whether a flow of liquid has been detected with respect to a valve (e.g., an ISV) or a set of valves.

In block 402, a flow of liquid may be detected in a valve. The detected flow may be the result of applying a pressure derivative (e.g., a pre-action valve control) and/or a pressure difference over the valve, optionally in connection with one or more sensors. The flow may have been generated in response to one or more input conditions, such as a fire having been detected, in response to a command to test the valve, etc.

In block 404, the valve may apply “intelligence” to the detected flow. For example, the valve may implement an averaging or filtering algorithm to guard against a false positive (e.g., reporting a flow when no such flow is actually present).

In block 406, a flow indication with respect to the valve may be communicated to one or more entities. For example, the flow indication may be communicated to another valve, a group of valves, an indication panel, etc. The communication of block 406 may be conditioned on the results of the applied intelligence of block 404. For example, if the flow does not persist for a threshold amount of time, the flow indication might not be communicated in block 406.

In block 408, the flow indication may be presented. For example, the flow indication may be presented on an indication panel (e.g., the indication panel 118), potentially in combination with flow indication status for one or more additional valves. The presentation of the flow indication may take one or more forms, such as a graphical display, an email, a text message, a voicemail, a document or report, etc. The presented flow indication may enable a user to identify a particular location or section of a building in which a fire may be present. Such a presentation may be made in connection with a map or diagram of the building.

In some embodiments, the flow indication results of block 408 may include an identification of a reason for the flow, such as a released sprinkler, a pump unit running, standby/jockey pumping, leakage, etc. Such an identification may be available as a result of application of pressure derivative techniques and/or the use of back flow preventing valves.

The method of FIG. 4 is illustrative. In some embodiments, one or more blocks or operations (or portions thereof) may be optional. In some embodiments, additional operations not shown may be included. In some embodiments, the operations may execute in an order or sequence different from what is shown in FIG. 4.

Embodiments have been described in terms of the control, management, and establishment of a sprinkler system. One skilled in the art will appreciate that embodiments may be adapted to accommodate different types of systems, such as different types of sprinkler systems.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Embodiments may be tied to one or more particular machines. For example, intelligence may be located in a valve. The location of the intelligence in the valve may simplify or streamline the design and implementation of a data aggregator, a collection point, or the like. The location of the intelligence in the valve may provide opportunities for additional functionality that was otherwise not possible. For example, remote monitoring, line monitoring, self-diagnostics, automatic self-testing, etc., may be easily performed.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A sprinkler system comprising:
a valve for discharging a liquid to suppress fire;
a sensor disposed at the valve, the sensor configured to provide an output indicating a flow of liquid; and
a processor disposed at the valve, the processer processing the output of the sensor to provide an indication of liquid flow at the valve.

2. The system of claim 1, wherein the processing comprises at least one of an averaging and a filtering algorithm.

3. The system of claim 2, wherein the at least one of an averaging and a filtering algorithm is a function of a time associated with a stabilization of pressure in the system.

4. The system of claim 1, further comprising:
a second valve for discharging a liquid to suppress fire;
a second sensor disposed at the valve, the second sensor configured to provide an output indicating a flow of liquid;
a second processor disposed at the second valve, the second processer processing the output of the second sensor to provide a second indication of liquid flow at the second valve.

5. The system of claim 4, wherein the valve and the second valve are directly coupled to one another via a medium, and wherein the medium is configured to provide support for potential free contacts.

6. The system of claim 4, wherein the valve and second valve form a group, and wherein the indication and second indication are communicated via a medium common to the group.

7. The system of claim 1, further comprising:
an indication panel configured to receive the indication from the valve and present the indication.

8. The system of claim 7, wherein the indication panel is configured to present the indication in accordance with at least one of a graphical display, an email, a text message, a voicemail, a document, and a report.

9. The system of claim 1, wherein the valve is configured to provide at least one of remote monitoring, line monitoring, self-diagnostics, and automatic self-testing.

10. A method comprising:
detecting, by a valve, a flow of liquid associated with a sprinkler system;
processing, at the valve, the detected flow; and
transmitting, by the valve, an indication of the detected flow based on the processing.

11. The method of claim 10, wherein the processing comprises at least one of an averaging and a filtering algorithm as a function of a time associated with a stabilization of pressure in the sprinkler system.

12. The method of claim 10, further comprising:
receiving, by the valve, an indication of a flow detected in a second valve from the second valve; and
transmitting, by the valve, the indication of the flow detected in the second valve.

13. The method of claim 10, wherein the transmitted indication of the detected flow comprises an identification of the valve.

14. The method of claim 10, further comprising:
presenting the indication in connection with a map or diagram of a building in which the sprinkler system is located.

15. The method of claim 10, wherein the indication of the detected flow comprises an indication of a released sprinkler and an indication that a second valve is to prepare for a pump starting and use of an averaging and a filtering algorithm.

16. The method of claim 10, wherein the valve comprises a back flow valve that is configured to prevent or slow down a back flow of liquid.

17. The method of claim 10, further comprising:
identifying a section in which a sprinkler of the sprinkler system is activated based on a drop in a pressure derivative associated with a second valve that is associated with the sprinkler.

18. The method of claim 10, wherein the section is identified based on the use of a back flow valve.

19. A valve for discharging liquid, comprising:
a sensor configured to provide an output indicating a flow of the liquid; and
a processor configured to process the output of the sensor and to provide an indication of liquid flow at the valve.

20. The valve of claim 19, further comprising:
a back flow valve configured to prevent or slow down a back flow of the liquid,
wherein the processor is configured to detect a condition of a slowed back flow based on at least one of a flow direction and a change in pressure.
